(19) United States
(12) Patent Application Publication
(10) Pub. No.: US 2017/0268713 A1
(43) Pub. Date: Sep. 21, 2017

(54) PHOTOCHEMICALLY CURABLE LINING HOSES FOR THE RENOVATION OF FLUID BEARING SYSTEMS

(71) Applicant: SML Verwaltungs GmbH, Rohrbach (DE)

(72) Inventors: Stefan REICHEL, Bad Duerkheim (DE); Christian NOLL, Limburgerhof (DE)

(73) Assignee: SML Verwaltungs GmbH, Rohrbach (DE)

(21) Appl. No.: 15/329,499

(22) PCT Filed: Jul. 29, 2015
(86) PCT No.: PCT/EP2015/067446

§ 371 Date: Jan. 26, 2017

(30) Foreign Application Priority Data
Jul. 31, 2014 (DE) 10 2014 110 928.7

(51) Int. Cl. F16L 55/165; B29C 63/34; B32B 27/12; B32B 1/08; B32B 7/12

(52) U.S. Cl. CPC F16L 55/1656; B32B 1/08; B32B 7/12; B32B 27/12; B29C 63/34; B32B 2310/0831; B32B 2398/20; B32B 2597/00; B32B 2307/412; B32B 2260/021; B32B 2260/046; B32B 2307/51; B29K 2101/12

(57) ABSTRACT

[symbol]

lining hose for the renovation of fluid carrying (fluid bearing) systems comprising

a) at least one inner tubular foil based on thermoplastic polymers mindestens einem inneren Folienschlauch auf der Basis eines thermoplastischen Kunststoffs,

b) at least one outer tubular foil based on thermoplastic polymers and

c) at least one fiber hose impregnated with a photochemically curing resin between one inner and one outer tubular foil wherein the outer tubular foil which is in contact with a resin impregnated fiber hose comprises functional groups on a surface which surface, in the installed state, is oriented towards the fiber hose and which functional groups undergo a reaction with the fiber hose.

The present invention relates to photochemically curable lining hoses for the renovation of fluid bearing (fluid carrying) systems comprising at least one inner tubular foil (foil hose), at least one outer tubular foil and a fiber hose impregnated with a photochemically curable resin between the two tubular foils. Further aspect of the present invention relates to a process for the manufacture of a respective lining hose.

In a particularly elegant process for the renovation of fluid carrying systems, in particular sewers and similar pipe systems a flexible fiber hose impregnated with a reactive resin which functions as lining hose (liner) is introduced into the canal, thereafter expanded so that it fits snugly to the inner wall of the canal and thereafter the resin is cured.

The manufacture of such a lining hose is e.g. described in WO 95/04646.In accordance with this reference a foil ribbon is helically wound (coiled) around a winding mandrel, which consists of several parallel winding fingers the distance of which to the axis of the winding mandrel can be adjusted individually, thereby forming an inner tubular foil (foil hose) functioning as protective foil. On top of this protective inner tubular foil at least one resin impregnated fiber ribbon is wound and on top of this wound fiber ribbon a second fiber ribbon is wound which forms the outer tubular foil (outer foil hose).

The outer tubular foil is intended to prevent leakage of the resin used for impregnation out of the fiber hose into the environment. This requires a good tightness and bonding of the outer tubular foil to the resin impregnated fiber hose.

in accordance with the teaching of EP 1180225 the outer foil in a lining hose in accordance with WO 95/04646 is laminated with a fleece layer to improve the bonding of the outer foil to the resin impregnated fiber hose. Fleece laminated foils are, however, tedious in their manufacture and the bonding effect achieved is not fully satisfactory.

In accordance with DE 10 2011 105 995 lining hoses with at least three layers comprising at least one inner tubular foil, at least one resin impregnated fiber hose and at least one outer tubular foil are described wherein the inner tubular foil which is in contact with a resin impregnated fiber hose comprises functional groups which undergo a reaction with the fiber hose on the surface of the inner tubular foil which is oriented towards the said fiber hose in the installed state. Thereby the bonding of the inner foil to the resin impregnated fiber hose should be improved and it should not be necessary to remove the inner foil after introduction and curing of the fiber hose. A fleece laminated outer foil is optionally used.

It was therefore an object of the present invention to provide photochemically curable lining hoses (lining tubes) for the renovation of fluid carrying systems which do not show the disadvantages outlined above.

This object is achieved in accordance with the present invention through lining hoses (lining tubes) for the renovation of fluid carrying systems with at least one inner tubular foil (foil hose) based on thermoplastic polymers, at least one outer tubular foil (foil hose) on the basis of thermoplastic polymers and at least one fiber hose impregnated with a photochemically curable resin between an inner and an outer tubular foil wherein the outer tubular foil which is in contact with one resin impregnated fiber hose comprises functional groups undergoing a reaction with the fiber hose on its surface which, in the installed state, is oriented towards the fiber hose.

A further aspect of the present invention relates to a process for the manufacture of the lining hoses in accordance with the present invention and the use of the lining hoses in accordance with the present invention for the renovation of fluid carrying pipe systems.

The term fluid, as used herein, generally denotes a medium which does not show measurable resistance against minimum shear strain. The superordinate term fluid designates gases and liquids as most of the physical laws are equally applicable for both states of aggregation and most of the properties differ only quantitatively but not qualitatively.

Just by way of example drinking water and supply water pipelines (pipe systems with which water is transported out of reserve storage tanks (reservoirs) or from the place of production to the location of use or to intermediate reservoirs), fluid carrying pipe systems of any kind in industrial environment in production plants or facilities or wastewater systems of any kind (e.g. sewers or wastewater collecting arrangements or the like).

The fluid carrying pipe systems may be so-called gravity lines (free-flow lines) or pressurized pipe systems such as pressurized water pipes, gas pipes or the like.

The term gravity line (in tunnels also referred to as free-flow tunnel or mirror tunnel) usually denotes a pipe respectively a section of a pipe in which water or a fluid medium flows in accordance with the law of gravity from a starting point at higher level to an endpoint at a lower level whereby the cross section of the pipe respectively the section of the pipe is normally not entirely filled with the flowing medium so that, different to a pressurized pipe, there is normally a free liquid surface area. The pipe is thus not fully filled with the liquid and an air volume remains which starts at the upper end (level or niveau) and, depending on pressure and solubility of the gas, extends more or less downwards. Since the liquid medium in a free-flow line is conveyed only by gravity, free-flow lines sometimes are also referred to as gravity lines.

The outer tubular foil with functional groups can be manufactured in accordance with any method known to the skilled person. It is e.g. possible to use preformed seamless hoses or hoses which are obtained by overlaying or bringing into contact the longitudinal rims of flat foils and connection of the overlaid or contacted rims through gluing or welding or through application of a foil ribbon. Furthermore, a suitable process for the manufacture of the outer tubular foil (outer hose) with functional groups is a winding method in which, as described in e.g. WO 95/04646, a foil ribbon is wound (coiled). All these processes are principally equally suitable and that skilled person will select the best suited process by taking into account the specific application situation based on his professional knowledge.

The method of introduction of the functional groups into the outer tubular foil is not subject to any particular limitation and all processes known to the skilled person and described in the literature may be used. The requirement is only that the functional groups are present on the surface at least for the time period which is required for the reaction with the fiber hose and preferably with the fiber material or in particular with the photochemically curable resin. To the extent the reaction takes place during curing only (which has shown to be advantageous in certain cases), a sufficient stability of the functional groups is required since the lining hoses in accordance with the present invention are usually pre-manufactured and there may be time periods of several weeks or months between production and curing in the pipe system to be renovated. If reaction during curing only has the advantage that during introduction (installation) and expanding the lining hose to fit same snugly (tightly) to the wall of the pipe system to be renovated no or only weak interactions between the outer foil and the fiber hose have to be expected, which interactions may have detrimental effects and may lead to the formation of wrinkles or similar problems.

Suitable functional groups are e.g. carboxylic acid, carboxylic acid anhydrides, carboxylic acid esters, carboxylic acid amides, carboxylic acid imides, amino, hydroxyl, epoxide, urethane and oxazoline groups, to mention only a few preferred examples. Particularly preferred are carboxylic acid, carboxylic acid anhydride and epoxide groups.

These groups may be obtained by copolymerization of respective monomers with other monomers which form the polymers of which the outer tubular foil is made or through joined use of polymers without functional groups with polymers with functional groups, preferably in the melt or through coextrusion.

To achieve a reaction between the functional groups of the inner foil and the resin it is necessary that the functional groups on the surface of the inner foil which, in the installed state, is oriented towards the resin- impregnated fiber belt, are accessible, i.e. have to be present on this surface. Composite foils based on polyolefins and polyamides in which the surface which is oriented towards the fiber ribbon does not comprise functional (e.g. carboxylic acid amide) groups and which have been described in the literature in respective photochemically curable systems as inner foils generally do not fulfill this requirement

Suitable reactive monomers for the introduction of suitable functional groups are e.g. maleic acid, maleic acid anhydride, itaconic acid, (meth)acrylic acid, and glycidyl(meth)acrylate as well as vinyl esters, in particular vinyl acetate, vinyiphosphonic acid, and their esters as well as ethylene oxide and acrylonitrile to mention only a few suitable examples.

The percentage of the comonomers for the introduction of the functional groups is in general in the range of from 0.1 to 50, preferably of from 0.3 to 30 and particularly preferred in the range of from 0.5 to 25 weight percent, based on the entire weight of the monomer mixture.

These monomers may be co-polymerized in the melt or in solution with the other monomers in accordance with known processes which have been described in the literature or may be reacted with polymers or monomers without functional groups by e.g. grafting.

During grafting the respective monomers are reacted with a pre-formed polymer backbone. Respective processes are known to the skilled person and have been described in the literature so that no further details need to be given here.

In the following some preferred groups of polymers are described in more detail; the invention is not limited, however, to these groups of polymers.

The structure and setup of the outer foil is not subject to any particular limitation with regard to monomer selection. If a resin curable by radiation is used in the fiber hose, outer foils are preferably used which are not transparent for the light used during curing. Thereby an improved protection against premature curing is achieved, which may occur through the interaction of light during the storage of the lining hoses prior to the installation. Since the light used for curing is usually UV radiation with wavelengths in the range of from 300 to 500 nm, preferably in the range of from 350 to 450 nm, the outer foil should have a high extinction respectively absorption in this range.

The extinction or absorption of foils is typically characterized through the transparency i.e. the capability of the investigated foil to transmit electromagnetic waves of the wavelength in question (transmission). Incoming photons interact, depending on their energy, with different components of the material and the transparency of material is thus dependent on the frequency of the electromagnetic wave.

A first exemplary group of preferred polymers are homopolymers or copolymers of olefins, in particular of α-olefins with preferably 2 to 8 carbon atoms, in particular 2 to 6 carbon atoms. Particular preferred monomers are ethene (ethylene), propene (propylene) and octene, whereby the latter is easily copolymerizable with ethene (ethylene).

As comonomers for the olefins mentioned before in particular alkyl acrylates or alkyl methacrylates derived from alcohols with 1 to 8 carbon atoms, e.g. ethanol, butanol or ethyl hexanol, to mention only some preferred examples, are suitable. Suitable reactive comonomers may be copolymerized with such monomers for the introduction of the functional groups described herein before

A first preferred group of such polymers with functional groups are copolymers of ethene with ethyl- or butylacrylate and acrylic acid and/or maleic acid anhydride. respective products are commercially available from BASF SE under the trade names Lupolen® KR1270

Copolymers of ethene and propene with suitable comonomers for the introduction of the functional groups are also suitable.

Furthermore, ethene/octene copolymers which are grafted with respective monomers for the introduction of functional groups may be mentioned. As example Fusabond® NM493D available from DuPont may be mentioned here.

In some cases so-called functionalized EPDM rubbers have found to be advantageous, which due to the elastic properties may have advantages in the course of the expansion of the lining hose to snugly (tightly) fit same to the wall of the system to be renovated. As examples terpolymers of usually at least 30 wt % ethene, at least 30 wt % propene, and up to 15 wt % of a diene component (usually diolefins with at least 5 carbon atoms such as dicyclopentadiene, 1,4-hexadiene or 5-ethylidene norbornene) may be mentioned. Royaltuf®485 available from Crompton can be mentioned as a commercially available representative.

Suitable polymers furthermore are polymers based on vinyl aromatic monomers and dienes, for example styrene and dienes, wherein the dienes may be fully or partially hydrogenated, and which contain respective functional groups. Such copolymers may be statistical or random copolymers or have a block structure, with mixed forms being possible (so-called tapered structures). Respective products have been described in the literature and are commercially available from various suppliers. As examples the commercial product lines Styrolux® and Styroflex® of BASF SE or styrene/ethene/butene copolymers functionalized with anhydride groups available under the tradename Kraton® G1901FX from Kraton Inc. may be mentioned.

The polymers of the outer foil may contain the functional groups in latent form, i.e. in a form in which the functional group itself is liberated during curing only.

It is furthermore possible to use mixtures of polymers wherein only one of the polymers comprises the functional groups or latent functional groups of the type mentioned above.

Suitable polymers with functional groups in this embodiment are polyamides, polyoxymethylene, acrylonitrile/butadiene/styrene (ABS) copolymers, polymethyl methacrylates, polyvinylacetates and polyvinyl alcohol.

In this embodiment it is important that the polar polymer is easily miscible with the polymer without functional groups. The mixing can advantageously be made in the melt of the polymers. The amount of added polymer with functional groups usually is in the range of from 0.01 to 50 weight percent, based on the weight of the mixture.

Taking into account the aforementioned criteria polyolefins such as polyethylene or polypropylene, polyamides, polyesters such as polybutylene terephthalate, polyethylene terephthalate or polyethylene naphthalate, poly vinyl chloride, polyacrylonitrile or thermoplastic polyurethanes or mixtures of such polymers are principally suitable. Furthermore, thermoplastic elastomers are also principally suitable. Thermoplastic elastomers are materials in which elastic polymer chains are embedded in thermoplastic material. Despite the lack of a vulcanization necessary for classical elastomers, thermoplastic elastomers show elastic properties, which may be advantageous in certain application areas. As examples polyolefin elastomers or polyamide elastomers may be mentioned here. Respective products have been described in the literature and are commercially available from various suppliers so that no further details need to be given here.

Instead of copolymerization or mixing or grafting the functional groups may also be introduced into the outer foil with the assistance of suitable adhesion promoters, which are applied onto the surface of the foils. Suitable adhesion promoters in this embodiment are e.g. silanes, solutions or melts of polar or functionalized polymers and suitable glues and adhesion promoter foils. These are preferably applied in a manner homogeneously covering the foil which forms the inner tubular hose to achieve a homogeneous distribution of the functional groups.

Finally, the functional groups mentioned above may also be obtained by surface treatment of the foils forming the outer tubular hose with reactive gases such as oxygen, fluorine or chlorine. Through the interaction of these media oxygen containing functional groups of the type mentioned as preferred above, such as acid-, acid anhydride or epoxide groups are formed on the surface. It should be mentioned here, however that the distribution of the functional groups at the surface is difficult to control, so that there is a higher probability of an inhomogeneous distribution compared to the products obtained in accordance with the processes described above of co-or graft polymerization or through the use of adhesion promoters. Furthermore type and amount of functional groups may be subject to higher fluctuation in this embodiment.

An introduction of functional groups may also be achieved by plasma or corona treatment. Respective processes are known per se to the skilled person and have been described in the literature. In some cases it has been observed, however that the content of functional groups obtained by corona treatment decreases over time, which may be disadvantageous if the lining hoses in accordance with the invention are stored for extended periods of time prior to the introduction into the pipe systems to be renovated.

Generally (and independent of the type of polymer), without, however, being limited thereto, the foil from which the at least one outer tubular foil (foil hose) is formed, has a thickness in the range of from 40 to 2000 μm, preferably in the range of from 50 to 1500 μm, particularly preferred in the range of from 80 to 1000 μm. The foil ribbon may also be selected with a respective greater thickness if a higher rigidity is desired.

The outer tubular foil (foil hose) may also comprise a reinforcement such as e.g. a fleece lamination as described in EP 1180 225.

If reinforcement means are used, the reinforcement means usually are based on fibers, in particular based on fiber ribbons.

Principally any product known to the skilled person in the form of fabrics, knitted fabrics, rovings, mats or non-wovens (fleeces) which may comprise fibers in the form of long endless fibers or short fibers, are suitable. The thickness of the reinforcement, e.g. the fleeces, preferably is in the range of from 0.005 to 2 mm, particularly preferred in the range of from 0.1 to 1 mm.

As component a) the lining hoses in accordance with the present invention comprise at least one inner tubular foil based on thermoplastic polymers.

The inner tubular foil in accordance with a preferred embodiment can also comprise functional groups on its surface which is oriented towards the resin impregnated fiber hose and which undergo a reaction with the fiber hose.

For the construction and the structure of such inner tubular foils (foil hoses) with functional groups what has been said above for the functional group containing outer tubular foils also applies; however, it has to be taken into account that the inner tubular foil should have a transparency as high as possible for the light used for irradiation and curing so that a quantitative and complete curing can be achieved.

in such cases where equipping the inner foil with functional groups does not appear necessary, polymer foils may be used obtainable from monomers used for the outer foil without the comonomers with functional groups.

As component c) the lining hoses in accordance with the present invention comprise at least one fiber hose impregnated with a curable resin located between the at least one inner and at least one outer foil hose (tubular foil).

Such a lining hose may be obtained through the winding of fiber ribbons on, respectively around, the inner tubular foil with a winding mandrel or a suitable other device or through folding and overlaying of fiber ribbons. Through the folding and overlaying of fiber ribbons a hose is formed, whereby the rims overlaying (laying on top of each other) optionally may be bonded together with suitable bonding methods such as needling or gluing.

Respective processes for the manufacture of such lining hoses are known per se to the skilled person and have been described in the literature so that no further details are necessary here. The advantages of the invention are not dependent on a specific process for manufacture of the lining hoses in accordance with the present invention.

In some cases lining hoses obtained in accordance with a winding process such as described e.g. in WO 95/04646 have been found to be particularly advantageous.

in accordance with a preferred embodiment the fiber hose impregnated with resin is obtained through winding of fiber ribbons using a device as described in WO 95/04646.

The resin impregnated fiber ribbons principally can have the same constitution (composition) as the reinforcement materials described above for the outer tubular foil.

Accordingly, all the products known to the skilled person in the form of fabrics, knitted fabrics, rovings, mats or non-wovens (fleeces) which may comprise fibers in the form of long endless fibers or short fibers, are suitable.

in accordance with a preferred embodiment the reinforcement on fiber basis is a glass fiber fabric or a glass fiber roving.

The term fabric (textile) generally denotes sheet-like textile products of at least two orthogonally crossed fiber systems, wherein the so-called warp extends in the longitudinal direction and the so-called weft (shute) extends in a direction orthogonal thereto.

In accordance with a preferred embodiment the lining hoses in accordance with the present invention comprise, in radial direction, at least two different resin impregnated fiber ribbons positioned on top of each other.

The term knitted fabric generally denotes textile products produced through the formation of meshs.

Fiber rovings or rovings are a processing variant of fibers, in which the fibers are not woven, but oriented parallel to each other embedded in a chemical carrier compound (the matrix) and which are fixed in place usually through cover foils on the upper and the lower surface. Rovings, due to the parallel orientation of the fibers usually show a pronounced anisotropy of stiffness or rigidity in the direction of the orientation and perpendicular thereto, which may be of interest for certain applications.

A non-woven or fleece consists of fibers loosely laid next to each other without being connected. The rigidity of a fleece solely rests on the fiber-inherent attraction, but may be influenced through further processing. In order be able to use and process a non-woven (fleece) same is usually solidified, for which solidification several methods may be used.

Fleeces differ from textiles (fabrics) or knitted fabrics, which are characterized by a particular and defined layering of the single fibers or filaments. Fleeces, in contrast, consist of fibers the orientation of which can only be described with statistical methods. The fibers are randomly oriented in the fleece. The English term non-woven thus clearly differentiates fleeces from textiles. Fleeces are differentiated according to the fiber material (e.g. the polymer in case of chemical fibers), the bonding process, the fiber type (staple or endless fibers), the denier of the fibers and the fiber orientation. The fibers may be oriented in a preferred direction or may be entirely stochastically oriented in the randomly oriented fleece.

If the fibers do not have a preferred direction for their orientation, the term isotropic fleece is used. If the fibers are oriented in one direction more often than in another direction, the term anisotropy is used.

Felts are also suitable as reinforcement for the tubular foil reinforced on both surfaces (sides). A felt is a sheet-like product based on unsorted and difficult to separate fiber material. In principle, felts are thus in principle textiles which are not woven: Felts are usually obtained from chemical fibers or natural plant-based fibers through dry needling (so called needled felts) or through solidification with water beams which exit from a beam with dies (die beam) under high pressure. The individual fibers in a felt are interlooped with each other in a random manner.

Needled felts are usually mechanically manufactured with a multiplicity of needles with flukes (barbs), wherein the barbs or flukes are positioned in reverse direction compared to a harpoon. Thereby, the fibers are pressed into the felt and the needle can be easily pulled out. Through repeated stitching the fibers are looped (entangled) with each other and thereafter optionally treated chemically or with water vapor.

Felts—as fleeces—may be manufactured from basically all natural or synthetic fibers. Besides needling or in addition to needling the fibers it is also possible to hook the fibers with a pulsed water beam or a binding agent. The latter methods are in particular suitable for fibers without scale structure such as polyester or polyamide fibers.

Felts show a good temperature stability and are usually hydrophobic, which may be an advantage in particular for the application in fluid-carrying systems.

Through the combined use of several different fiber ribbons with different constitution (composition) with regard to fiber type, fiber length, fiber bonding or fiber orientation the property profile of the lining hoses in accordance with the present invention can be individually adapted to the specific application case without extensive modifications in the devices used for the manufacture becoming necessary. Through the choice or the sequence in which the at least two different fiber ribbons are arranged it is possible to adapt the radial and longitudinal profile of the lining hoses in accordance with the present invention optimally to the specific application case.

The length of the fibers used in fiber-containing reinforcing elements is not subject to a particular limitation, i.e. so-called long fibers as well as short fibers or fiber fragments may be used. The length of the fibers may be used to adjust and control the properties of the respective fiber belts (ribbons) over a wide range.

The type of fibers used is not subject to particular limitations either. Only by way of example glass fibers, carbon fibers or polymer fibers such as aramide fibers or fibers based on thermoplastic polymers such as polyesters or polyamides or polyolefins (e.g. polypropylene) shall be mentioned here, which are known to the person skilled in the art with their properties and which are commercially available in great variety. For economic reasons, glass fibers are usually preferred; if e.g. a particular heat resistance is of importance, however, aramide fibers or carbon fibers may be used, which may offer advantages compared to fibers based on thermoplastic polymers as far as rigidity or stiffness at higher temperatures is concerned.

in some cases it has been found to be advantageous if a first resin impregnated fiber ribbon is selected from fabrics, knitted fabrics, rovings, mats, felts or fleeces whereby the length of the fibers may be selected in accordance with the desired application. The first resin impregnated fiber ribbon may be a fiber roving of parallel oriented endless fibers, preferably parallel oriented endless glass fibers. Preferably the endless fibers are oriented substantially orthogonal to the longitudinal direction of the resin impregnated fiber ribbon. A second fiber ribbon may be preferably combined with such first fiber ribbon, wherein in the second fiber ribbon the fibers are stochastically (randomly) oriented in a fiber mat. The first fiber ribbon provides a good rigidity in the longitudinal direction, which is advantageous during the introduction into the pipe systems to be renovated. The second fiber ribbon with stochastically (randomly) oriented fibers stabilizes the inner surface through its high resin uptake and thereby avoids pores on the inner surface which may lead to damages upon extended contact with aggressive media. Through the use of an oriented fiber roving on the other side the risk that the fiber mat upon impregnation may be drawn apart and thereby an inhomogeneous impregnation may occur, is reduced. Static requirements for the lining hose also render advantageous such an embodiment.

In accordance with a preferred embodiment in a first resin impregnated fiber ribbon the fiber roving may be needled or sewed with a random fiber mat, i.e. the first and also the subsequently introduced fiber ribbons may comprise several layers. In some cases it has found to be advantageous in such embodiment if at least one fiber ribbon positioned on top of a first fiber ribbon has a multi layer structure such that between two layers with randomly oriented fibers an intermediate layer with cut fibers oriented parallel to the longitudinal direction of the fiber ribbon is contained, wherein the cut fibers preferably have a length in the range of from 2 to 200, preferably of from 3 to 40 cm.

In accordance with a particularly preferred embodiment the lining hoses in accordance with the invention comprise a resin impregnated fiber hose which contains at least one fiber ribbon with fibers substantially oriented perpendicular to the longitudinal direction of the fiber ribbon and at least one further fiber ribbon with fibers oriented parallel to the longitudinal direction of the fiber ribbon.

In accordance with a further preferred embodiment a fleece, preferably a fleece of polyolefin fibers, particularly preferred a fleece of propylene fibers is used as first resin impregnated fiber ribbon, which may be combined with any further fiber ribbon of the type described before.

As mentioned above, it is principally possible to combine any two types of fiber ribbons which achieve the property profile best suited for the intended application. Thus, fiber belts with identical fiber bonding (e.g. two fiber rovings or two fiber fabrics) may be used which contain fibers of different chemical composition, different orientation or which have different lengths. Four example short fibers in one fiber ribbon may be combined with long fibers in at least one further fiber ribbon or fabrics may be combined with fleeces, mats or rovings. The use of two fiber fabrics with fibers having the same type of bonding and the same orientation and length but of different chemical composition is also possible. This opens a great scope of variation for the skilled person within which the skilled person may tailor the properties of the lining hose for the individual application case.

Starting with the desired property profile the skilled person will select the suitable fiber ribbons for the lining hoses in accordance with the invention using his professional knowledge about the properties of the various types of fiber ribbons and the skilled person is thus capable to provide products optimally adopted to the individual application situation.

The impregnation of the impregnated fiber ribbons with resin is made in accordance with methods known per se. Respective processes are known to the skilled person and have been described in the literature so that no further explanations need to be given here.

The skilled person will select the resin used for impregnation depending on the type of fiber reinforcement and the necessary properties for the individual application case. Resins for the impregnation of fiber systems have been described in great variety in the literature and are known per se to the skilled person.

A first preferred group of reactive resins are unsaturated polyester resins or vinyl ester resins, which may be dissolved e.g. in styrene and/or an acrylic acid ester. Suitable reactive resins of these types are known to the skilled person and commercially available in different grades.

Furthermore a number of epoxide resins (one component systems as well as two component systems) have been described in the literature from which the skilled person may choose in case of need.

The reactive resins may be cured e.g. with electromagnetic radiation e.g. with UV radiation with a photo initiator as described for example in EP-A 23634. Thermally curing resins are also known and suitable. Furthermore so-called combination curings with an initiator suitable for thermal curing (e.g. a peroxide initiator) in combination with a photo initiator as mentioned are possible and have been found advantageous in particular at higher wall thicknesses of the lining hoses. A method for such a combination curing is e.g. disclosed in EP A1 262 708.

After impregnation the resin can be advantageously thickened as described for example in WO A 2006/061129. Thereby the viscosity of the resin is increased and the processability of the fiber ribbons used is improved.

The width of the fiber ribbons is not subject to particular limitations; for a variety of applications fiber ribbons with a width of from 20 to 150, preferably of from 30 to 100, particularly of from 40 to 80 cm have been found suitable.

The thickness of the fiber resins in the lining hoses according to the present invention is not subject to particular limitations either and is determined by the thickness of the lining hose for the desired application. Thicknesses of the fiber ribbons in the range of from 0.01 to 1, preferably of from 0.05 to 0.5 mm have been successfully used in practice.

The final lining hose which usually has a length of from 1 to 1000 m, in particular of from 30 to 300 m, in the course of the pipe renovation is introduced into the pipe system to be renovated and, after introduction, expanded either with pressurized water or preferably with air so that it tightly fits to the inner wall of the pipe system to be renovated. Thereafter the resin is cured with electromagnetic radiation as described e.g. in EP A 122 246 and DE-A 198 17413.

The lining hoses in accordance with the present invention may be manufactured in accordance with the methods disclosed in WO 95/04646 using the respective devices described therein and to which reference is made here with for further details.

in accordance with a preferred process the lining hoses in accordance with the present invention are obtainable by a process wherein first

a) the longitudinal rims of a flat foil made of thermoplastic polymers are brought together and thereafter a foil ribbon the elasticity module of which in the direction orthogonal to the longitudinal direction exceeds the elasticity module of the flat foil in the respective direction measured under the same conditions and the foil ribbon as connected with the flat foil is applied onto the rebord in longitudinal direction thereby building a foil hose or tubular foil

b) thereafter at least one resin impregnated fiber ribbon is applied onto the tubular foil on the reinforced surface thereof obtained in step a) in a manner that a resin impregnated fiber hose is formed, and

c) finally an outer tubular foil (foil hose) is applied on top of the product obtained in step b), which surrounds (envelops) the said product.

Devices with which the longitudinal rims of a flat foil may be brought into contact are known to the skilled person and described in the literature so that further explanations are not necessary here. Just by way of example reference may be made to WO 95/04646, in particular FIG. 12 thereof and the respective explanations in the specification and to WO 90/011175wherein respective devices are shown and described.

The application of the foil ribbon onto the rebord obtained by the bringing into contact or overlaying of the longitudinal rims may be effected in a manner known per se; a respective foil ribbon may be drawn e.g. parallel to the flat foil from a respective device, in particular from a roller (bobbin) and applied onto the rebord. There is no need for particularly sophisticated constructions as commercially available devices may be used.

The bonding of the foil ribbon with the flat foil can preferably be made through gluing or welding, of which welding is particularly preferred since thereby a homogeneous composite material is obtained. In the case of gluing care has to be taken that the glue used is stable under the conditions of the application. In the case of the resins most frequently used this requires inter alia a stability against styrene. The glue necessary for gluing may either be applied already on the foil ribbon (in this case the fiber ribbon is a so-called adhesive tape) or it may be introduced with a respective dosing device between foil ribbon (tape) and the flat foil. Suitable glues are known per se and have been described in the literature, so that no further details are necessary here. The skilled person will, based on the materials used for foil ribbon and flat foil, select a glue which leads to the best possible bonding between flat foil and foil ribbon.

The lining hoses in accordance with the present invention are suitable for the renovation of fluid carrying systems of any type and make possible a quick renovation with minimized off-service times of that pipe systems, within which they have to be taken out of operation. Compared to the replacement of damaged parts the off-service times are reduced. Particularly preferably the lining hoses in accordance with the present invention may be used for the renovation of such systems which are only accessible with difficulties for a classical repair or a renovation with the exchange of parts, for example because the systems are components of an overall device or because the systems are not accessible e.g. because they are laid underground in the soil. Examples for such pipe systems are a systems for the transportation of water or wastewater (sewer systems and the like) which are normally laid underground in the soil in cities and villages and frequently below roads or other traffic pathways. In the case of renovation through the exchange of damaged parts these systems have to be excavated first by respective digging efforts and the traffic pathways are not accessible and usable for traffic over longer periods of time, which is in particular detrimental in case of high traffic volume. Compared to this method the renovation of such systems with the lining hoses in accordance with the invention may be achieved in a few hours or days without extensive excavation and digging work.

The use of the lining hoses in accordance with the present invention for the renovation of water and wastewater pipe systems, in particular of sewers, is a further embodiment of the present invention.

Listing of claims:

1. Lining hose for the renovation of fluid bearing pipe systems comprising
a) at least one inner tubular foil based on thermoplastic polymers
b) at least one outer tubular foil based on thermoplastic polymers, and
c) at least one fiber hose impregnated with a photochemically curing resin between one inner and one outer tubular foil wherein the outer tubular foil which is in contact with a resin impregnated fiber hose comprises functional groups on a surface which surface, in the installed state, is oriented towards the fiber hose and which functional groups undergo a reaction with the fiber hose.

2. Lining hose in accordance with claim 1, characterized in that the functional groups are selected from the group consisting of carboxylic acid groups, carboxylic acid anhydride groups, carboxylic acid ester groups, carboxylic acid amide groups, carboxylic acid imide groups, amino groups, hydroxyl groups, epoxide groups, urethane groups and oxazoline groups.

3. Lining hose in accordance with claim 1, characterized in that the functional groups are carboxylic acid groups, carboxylic acid anhydride groups or epoxide groups.

4. Lining hose in accordance with claim 1, characterized in that the inner tubular foil comprises functional groups undergoing a reaction with the fiber hose on the surface which, in the installed state, is oriented towards the resin impregnated fiber hose.

5. Lining hose in accordance with claim 1, characterized in that the inner tubular foil has a thickness in the range of from 40 to 800 μm.

6. Lining hose in accordance with claim 1, characterized in that the transparency of the inner foil for electromagnetic radiation with a wavelength used for curing, in particular at the wavelength at which the initiators in the resin used for impregnation decompose is more than 50%.

7. Lining hose in accordance with claim 1, characterized in that the functional groups are obtained through copolymerization of respective monomers with further monomers from which the polymers forming the inner foil are made or through that joined use of polymers without functional groups with polymers with functional groups.

8. Lining hose in accordance with claims claim 1, characterized in that the functional groups are obtained by surface treatment of the foil forming the outer tubular foil hose with gases.

9. Lining hose in accordance with claim 1, characterized in that the functional groups are applied onto the foil forming the outer tubular foil hose with adhesion promoters.

10. (canceled)

11. Lining hose in accordance with claim 1, characterized in that the transparency of the inner foil for electromagnetic radiation with a wavelength used for curing, in particular at the wavelength at which the initiators in the resin used for impregnation decompose is more than 60%.

12. Lining hose in accordance with claim 1, characterized in that the functional groups are obtained through copolymerization of respective monomers with further monomers from which the polymers forming the inner foil are made or through that joined use of polymers without functional groups with polymers with functional groups in the melt or by coextrusion.
